(19) United States
(12) Patent Application Publication
(10) Pub. No.: US 2026/0051768 A1
(43) Pub. Date: Feb. 19, 2026

(54) WIRELESS POWER TRANSFER SYSTEM

(71) Applicant: AETERLINK CORP., Tokyo (JP)

(72) Inventors: Akito MURAI, Tokyo (JP); Naoto KODATE, Tokyo (JP)

(21) Appl. No.: 19/368,519

(22) Filed: Oct. 24, 2025

Related U.S. Application Data
(63) Continuation-in-part of application No. PCT/JP2024/006710, filed on Feb. 26, 2024.

(30) Foreign Application Priority Data
Apr. 27, 2023 (JP) 2023-073247

(51) Int. Cl. H02J 50/40; H02J 50/20; H02J 50/80

(52) U.S. Cl. CPC H02J 50/40; H02J 50/20; H02J 50/80

(57) ABSTRACT

A wireless power transfer system includes at least one transmitter and a plurality of receivers, wherein the transmitter is capable of wirelessly transfer power to the plurality of receivers, and the plurality of receivers are capable of performing wireless communication with the transmitter by using radio wave intensities that vary in a time sequence so as to suppress interference among the respective receivers.

### CROSS-REFERENCE TO RELATED APPLICATIONS

This application is a Continuation-in-Part of International Application No. PCT/JP2024/006710, filed on February 26, 2024, which claims the benefit of priority to Japanese Patent Application No. 2023-073247, filed on April 27, 2023, the entire contents of both of these applications are hereby incorporated by reference.

### FIELD OF THE INVENTION

The present disclosure relates to a wireless power transfer system.

### BACKGROUND

Techniques for wirelessly transmitting electric power are known. Patent Document 1 discloses a technique in which, in a wireless power transfer system, divergence or vibration is not generated in a rectified voltage of a receiver even when a feedback delay becomes long.

Patent Document 2 discloses a technique for providing a system and method for optimally delivering pulsed wireless power using a transmitter assembly that is beneficial for optimizing the delivery of wireless power to a plurality of receivers.

### PRIOR ART DOCUMENTS

[Patent Document 1] Japanese Patent Application Publication No. 2018-196290 JP

[Patent Document 2] Japanese Patent Application Publication No. 2019-170154 JP

### SUMMARY OF THE INVENTION

### Problem to be solved by the invention

Here is a problem that interference of communication radio waves cannot be suppressed when communication is performed between a transmitter and a plurality of receivers.

The present disclosure has been made to solve the above problems, and an object thereof is to provide a technique for suppressing interference of communication radio waves when communication is performed between a transmitter and a plurality of receivers.

### Means for solving the problem

A wireless power transfer system is configured to include at least one transmitter and a plurality of receivers. The transmitter is capable of wirelessly transfer power to the plurality of receivers. In addition, the plurality of receivers are capable of performing wireless communication with the transmitter by using radio wave intensities that vary in a time sequence so as to suppress interference among the respective receivers.

### Effects of the Invention

According to the present disclosure, when communication is performed between a transmitter and a plurality of receivers, interference of communication radio waves can be suppressed.

### BRIEF DESCRIPTION OF THE DRAWINGS

FIG. 1 is a diagram showing the entire configuration of a WPT device according to an embodiment of the present invention.

FIG. 2 is a block diagram showing a configuration example of a transmitter 100, a receiver 200.

FIG. 3 is a block diagram showing a basic hardware configuration of the computer 90.

### DESCRIPTION OF THE PREFERRED EMBODIMENTS

Hereinafter, embodiments of the present disclosure will be described with reference to the drawings. In all the drawings describing the embodiments, the same components are denoted by the same reference numerals, and repeated description thereof is omitted. Note that the following embodiments do not unduly limit the contents of the present disclosure described in the claims. In addition, not all of the constituent elements shown in the embodiments are necessarily essential constituent elements of the present disclosure. In addition, the drawings are schematic diagrams, and are not necessarily strictly illustrated.

### Overview

### 1 Configuration of the entire system

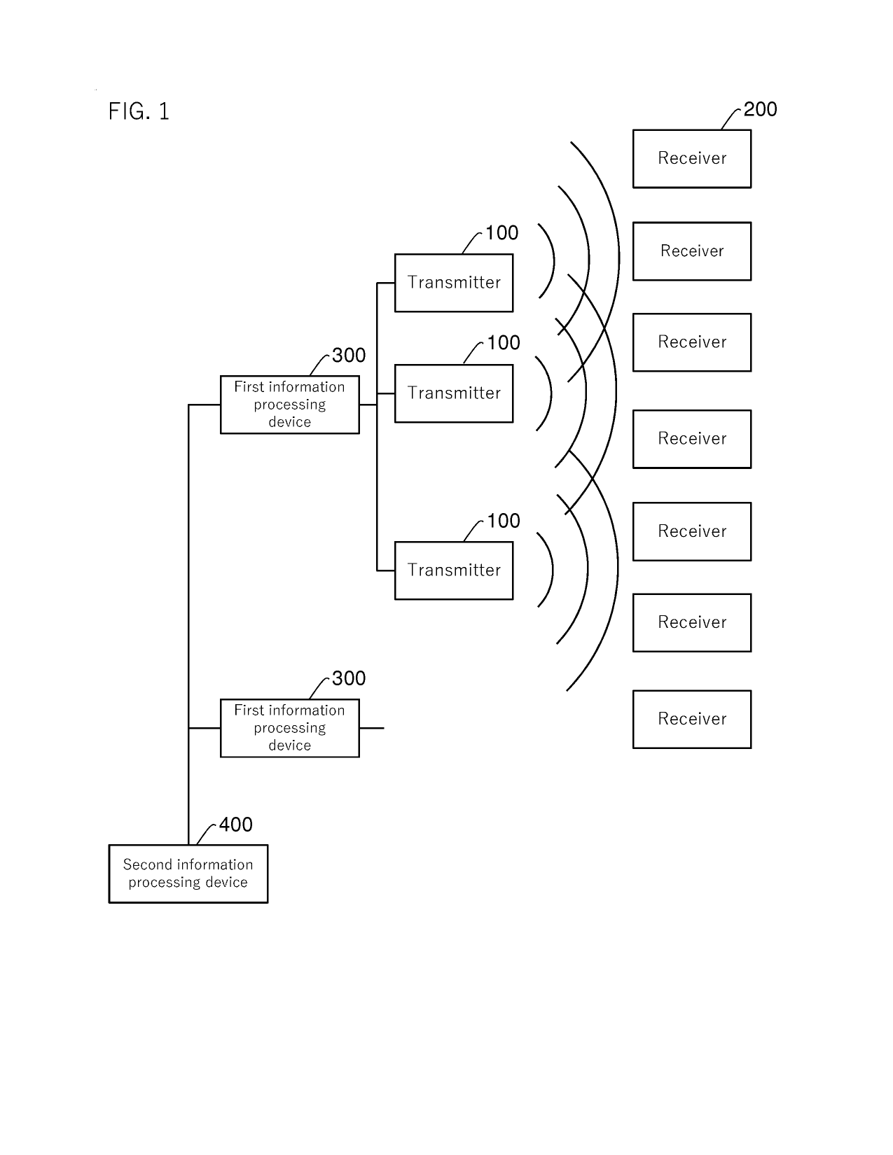

FIG. 1 is a diagram illustrating an entire configuration of a wireless power transfer system or WPT system (wireless power transfer system) 1 according to the present embodiment.

The WPT system 1 illustrated in FIG. 1 includes, for example, a transmitter 100, a receiver 200, a first information processing device 300, and a second information processing device 400. The WPT system 1 illustrated in FIG. 1 is used in, for example, a building or a factory. The connection between the transmitter 100 and the first information processing device 300 and the connection between the first information processing device 300 and the second information processing device 400 may be wired or wireless.

The WPT system 1 according to the present disclosure is applicable to the field of FA(Factory Automation) equipment, robotic equipment, and the like.

Specifically, by applying the WPT system 1 to a FA device, a robotic device, or the like, it is possible to reduce the cost of wiring and the maintenance cost associated with wiring. Further, it is possible to suppress a failure or the like due to disconnection.

The WPT system 1 can be applied to an automated transfer robot (AGV), an autonomous mobile robot (AMR), and the like. Automatic transfer robots and autonomous mobile robots are used for transporting parts and products in a factory. By using the wireless power supply system, power can be supplied to the robot even when the robot is stopped, and the operation time can be extended and the waiting time in the charging station can be reduced.

The WPT system 1 can be applied to an industrial robotic arm. Industrial robotic arms are used for tasks such as assembly, test, welding, etc. The introduction of the wireless power supply system eliminates the power cable and makes the robot more free to move. As a result, the work efficiency is improved, and the restriction on the installation location is relaxed. Further, it is possible to suppress a maintenance cost associated with wiring, a failure due to disconnection, and the like.

The WPT system 1 can be applied to sensors and surveillance cameras. By applying a wireless power supply system to sensors and monitoring cameras for monitoring the temperature, humidity, vibration, and the like in the factory, battery replacement and wiring work become unnecessary. As a result, the maintenance cost is reduced and more sensors can be easily installed.

The WPT system 1 can be applied to smart factory. The WPT system 1 facilitates connecting devices and devices in a smart factory, and enables real-time communication and remote control. As a result, the production efficiency of the smart factory can be improved, and the downtime can be reduced.

In FIG. 1, the WPT system 1 includes three transmitters 100, but the number of transmitters 100 included in the WPT system 1 is not limited to three transmitters. The number of transmitters 100 included in the WPT device 1 may be two or less, or four or more.

In FIG. 1, the WPT system 1 includes seven receivers 200, but the WPT system 1 includes seven receivers 200. The number of receivers 200 included in the WPT device 1 may be six or less, or eight or more.

In FIG. 1, the WPT system 1 includes two first information processing devices 300, but the number of first information processing devices 300 included in the WPT system 1 is not limited to two. The first information processing device 300 included in the WPT system 1 may be one or three or more.

The transmitter 100 is capable of wirelessly powering a plurality of receivers 200.

Specifically, the transmitter 100 transmits, for example, a power supply signal or a data signal (hereinafter, collectively referred to as a wireless signal) to the receiver 200. For example, the transmitter 100 transmits a power supply signal to the receiver 200 by radio waves in a 920MHz band (supplies radio power). The transmitter 100 transmits a data-signal to the receiver 200 by, for example, a radio wave in a 2.4GHz band. The transmitter 100 may transmit the data-signal by radio waves in a 920MHz band. The receiver 200 may transmit the data signal to the transmitter 100 by radio waves in a 2.4GHz band.

For example, the transmitter 100 may transmit a power supply signal to one receiver 200 or may transmit a power supply signal to a plurality of receivers 200. For example, the transmitter 100 may transmit a data signal to one receiver 200 or may transmit a data signal to a plurality of receivers 200. The transmitter 100 may transmit the same data signal as the other transmitter 100 or may transmit a different data signal than the other transmitter 100, for example. For example, the transmitter 100 may transmit a predetermined command signal as a data signal to the receiver 200, or may transmit a preset signal as a data signal to the receiver 200.

The transmitter 100 receives, for example, a data signal transmitted from the receiver 200. For example, the transmitter 100 may receive data signals transmitted from one receiver 200 or may receive data signals transmitted from a plurality of receivers 200. The transmitter 100 transmits the data signal transmitted from the receiver 200 to the first information processing device 300. The transmitter 100 transmits information on the state of the transmitter 100 to the first information processing device 300.

The receiver 200 receives, for example, a power supply signal or a data signal transmitted from the transmitter 100. For example, when the receiver 200 includes a battery, the power supply signal transmitted from the transmitter 100 is converted into power, and the converted power is stored in the battery. For example, when the receiver 200 includes a predetermined sensor, the power supply signal transmitted from the transmitter 100 is converted into power, and the sensor is driven by the converted power.

The receiver 200 transmits, for example, information regarding the state of the receiver 200 or information regarding the measurement result by the sensor to the transmitter 100 as a data signal. That is, the plurality of receivers 200 can transmit the sensing data acquired by the sensing device included in the receiver 200 to the transmitter 100 via wireless communication.

The first information processing device 300 is an information processing device that monitors operations of the transmitter 100 and the receiver 200 accommodated in the WPT system 1. For example, the first information processing device 300 determines whether or not the transmitter 100 or the receiver 200 is in a preset state based on the information on the conditions of the transmitter 100 and the receiver 200 transmitted from the transmitter 100. When it is determined that the state is set in advance, the first information processing device 300 transmits predetermined information to the second information processing device 400.

The first information processing device 300 accumulates information about the transmitter 100 and the receiver 200 accommodated in the WPT system 1. For example, the first information processing device 300 stores information on the conditions of the transmitter 100 and the receiver 200 transmitted from the transmitter 100 in a storage unit provided in the first information processing device 300.

The first information processing device 300 controls the operation of the transmitter 100 accommodated in the WPT system 1.

The first information processing device 300 controls the operation of the transmitter 100 accommodated in the WPT system 1. For example, the first information processing device 300 transmits a predetermined instruction or information to the transmitter 100.

The first information processing device 300 controls the operation of the second information processing device 400.

The second information processing device 400 is, for example, an information processing device operated by an administrator of the WPT system1. When the second information processing device 400 receives, from the first information processing device 300, a message indicating that the transmitter 100, the receiver 200, or both of them accommodated in the WPT system 1 are in a predetermined condition, it presents to the user that the transmitter 100, the receiver 200, or both of them are in a predetermined state.

The second information processing device 400 analyzes the information on the conditions of the transmitter 100 and the receiver 200 stored in the first information processing device 300, and presents predetermined information to the user. The predetermined information is, for example, as follows.

### 1.1 Configuration of Transmitter and Receiver

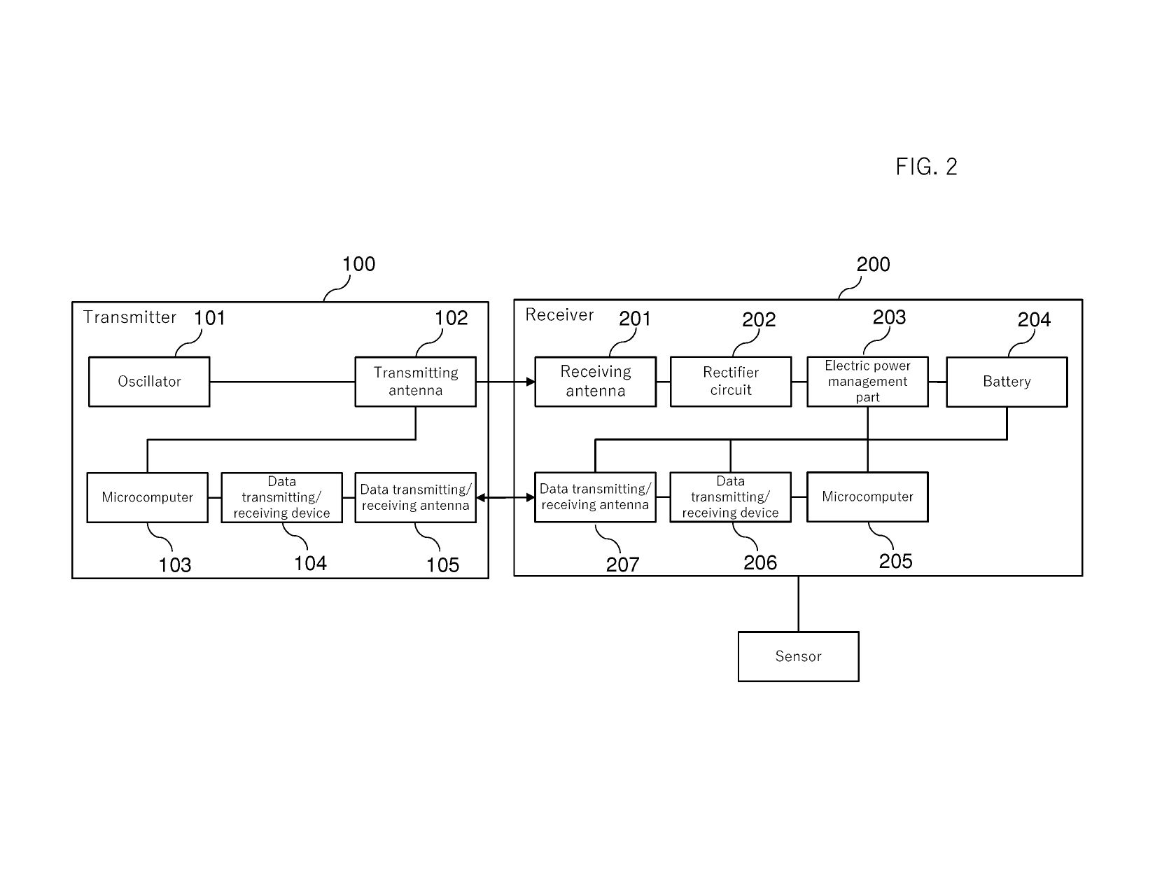

FIG. 2 is a block diagram illustrating a configuration example of the transmitter 100 and the receiver 200 illustrated in FIG. 1. As shown in FIG. 2, the transmitter 100 and the receiver 200 are, for example, spaced apart from each other by a predetermined interval. For example, the transmitter 100 and the receiver 200 are separated from each other by a distance of about several meters. Specifically, for example, the transmitter 100 is fixedly installed at an indoor high position, for example, at a predetermined high position provided on a ceiling or a wall. The receiver 200 is installed in a predetermined device indoors or placed in the vicinity of a device requiring power supply. The receiver 200 may also be carried by a user. The transmitter 100 transmits a power supply signal to the receiver 200 using a radio wave of a predetermined frequency, for example, a 920MHz band. The receiver 200 converts the power supply signal transmitted from the transmitter 100 into power, and charges the converted power or supplies the converted power to a predetermined device.

The transmitter 100 includes, for example, an oscillator 101, a transmitting antenna 102, a microcomputer (controller) 103, a data transmitting/receiving device 104, and a data transmitting/receiving antenna 105. The oscillator 101, the microcomputer 103, the data transmitting/receiving device 104, the data transmitting/receiving antenna 105, or at least one of them may be mounted on a PCB (printed circuit board), for example.

The oscillator 101 oscillates a signal in a predetermined frequency band, for example, a 920MHz band. The oscillated signal may be amplified to remove unwanted frequency components, if desired.

For example, the transmitting antenna 102 is formed so as to be capable of efficiently transmitting radio waves in a 920MHz band. The transmitting antenna 102 radiates the signal oscillated by the oscillator 101 as a power supply signal.

The microcomputer 103 controls the operation of the transmitter 100. The microcomputer 103 is realized by, for example, a single-board computer equipped with a ARM processor. For example, the microcomputer 103 controls transmission of radio waves by the transmitting antenna 102.

The data transmitting/receiving device 104 performs processing such as analog conversion of digital data and modulation of analog data. Further, the data transmitting/receiving device 104 performs processing such as demodulation of a data signal received by the data transmitting/receiving antenna 105 and digitization of demodulated data. For example, the data transmitting/receiving device 104 extracts a predetermined signal from a data signal received by the data transmitting/receiving antenna 105, converts the extracted signal into digital data, and transmits the digital data to the microcomputer 103.

For example, the data transmitting/receiving antenna 105 is formed so as to be capable of efficiently transmitting and receiving radio waves in a 2.4GHz band. The data transmitting/receiving antenna 105 emits a data signal supplied from the data transmitting/receiving device 104. Further, the data transmitting/receiving antenna 105 receives the data signal transmitted from the receiver 200.

The receiver 200 includes, for example, a receiving antenna 201, a rectifier(rectifier circuit) 202, an electric power management part 203, a battery 204, a microcomputer 205, a data transmitting/receiving device 206, and a data transmitting/receiving antenna 207. The receiving antenna 201, the rectifier 202, the electric power management part 203, the battery 204, the microcomputer 205, the data transmitting/receiving device 206, the data transmitting/receiving antenna 207, or at least any combination thereof may be mounted on, for example, a PCB or a FPC (flexible board).

For example, the receiving antenna 201 are formed so as to be capable of efficiently receiving radio waves in a 920MHz band. The receiving antenna 201 receives the power supply signal radiated from the transmitting antenna 102.

The rectifier 202 rectifies a radio wave received as a power supply signal and converts the rectified radio wave into a DC voltage.

The electric power management part 203 manages a DC voltage. For example, the electric power management part 203 controls the charging voltage based on the DC voltage. The electric power management part 203 charges the battery 204 by controlling the charging voltage. In addition, the electric power management part 203, for example, supplies a DC voltage to a connected member when power of a predetermined capacity or more is stored in the battery 204.

In addition, the electric power management part 203 causes the electric power stored in the battery 204 to be discharged under control of the microcomputer 205.

The battery 204 stores power in response to an instruction from the electric power management part 203. Further, the battery 204 emits the stored electric power in response to an instruction from the electric power management part 203.

The microcomputer 205 controls the operation of the receiver 200. The microcomputer 205 is driven by a DC voltage supplied from the electric power management part 203 or electric power stored in the battery 204. The microcomputer 205 controls the electric power management part 203 to release the electric power stored in the battery 204.

Various sensors can be connected to the receiver 200, for example. For example, a thermal sensor, a temperature sensor, an optical sensor, a humidity sensor, a vibration sensor, etc. are connected to the receiver 200. The sensor connected to the receiver 200 is driven by, for example, a DC voltage supplied from the electric power management part 203 or electric power emitted from the battery 204. The microcomputer 205 continuously or intermittently monitors a voltage value at a predetermined portion of the receiver 200, a status of a sensor connected to the receiver 200, information detected by the sensor, and the like. The microcomputer 205 transmits, as digital data, a voltage value at a predetermined portion of the receiver 200, a status of a sensor connected to the receiver 200, information detected by the sensor, and the like to the data transmitting/receiving device 206. Note that the sensor may be built in the receiver 200.

The data transmitting/receiving device 206 performs processing such as analog conversion of digital data supplied from the microcomputer 205 and modulation of analog data. Further, the data transmitting/receiving device 206 performs processing such as demodulation of a data signal received by the data transmitting/receiving antenna 207 and digitization of demodulated data. The data transmitting/receiving device 206 is driven by, for example, a DC voltage supplied from the electric power management part 203 or power emitted from the battery 204.

For example, the data transmitting/receiving antenna 207 is formed so as to be capable of efficiently transmitting and receiving radio waves in a 2.4GHz band. The data transmitting/receiving antenna 207 emits a data signal supplied from the data transmitting/receiving device 206. Further, the data transmitting/receiving antenna 207 receives the data signal transmitted from the transmitter 100. For example, the data transmitting/receiving antenna 207 is driven by, for example, a DC voltage supplied from the electric power management part 203 or electric power emitted from the battery 204.

In the above-described embodiments, the transmission power including the AC signal is transmitted from the transmitter 100 to the receiver 200 wirelessly, and the application to the so-called WPT system 1 has been described, but the application to a system that provides power to the receiver 200 by other methods is also applicable. Since such a system is known, a detailed description thereof will be omitted, but examples thereof include a system that transmits electric power generated by photovoltaic power generation to the receiver 200 regardless of whether it is wired or wireless, and a system that transmits electric power to the receiver 200 regardless of whether it is wired or wireless by laser light. Alternatively, the present invention can be applied to a configuration in which vibration or sound is applied to the receiver 200 and the receiver 200 converts power such as vibration into electric power. In addition, the present invention is also applicable to a system using a known contactless power supply art other than wirelessly receiving a transmission power including an AC signal, and a contactless power supply technique using a magnetic field coupling method as an example.

### Operation of WPT 1

The processes of the WPT system 1 will be described below.

The microcomputer 205 of the receiver 200 can control the radio wave control of the wireless communication according to the following first to third embodiments. Hereinafter, the details of the radio control will be described.

In the present disclosure, a wireless signal (data signal) transmitted by the receiver 200 is disclosed as an example. Note that the present invention may be applied to a wireless signal (at least one of a power supply signal or a data signal) transmitted by the transmitter 100.

### First Embodiment

The plurality of receivers 200 can perform wireless communication so as to suppress interference of the respective receivers 200 with different time sequence radio wave intensities for the transmitter 100.

Specifically, when transmitting the radio signal, the receiver 200 may select one radio wave intensity level from among five radio wave intensity levels Lv1, Lv2, Lv3, Lv4 and Lv5 to transmit the radio signal. For example, it is assumed that a plurality of stages of radio wave intensity levels and Lv1, Lv2, Lv3, Lv4, Lv5 correspond to radio wave intensity levels and-10dBm, -5dBm, 0dBm, +3dBm, +5dBm, respectively. Note that the radio wave intensity level is not limited to the above-described five levels, and may be divided into levels of less than five levels, or may be divided into levels of more than five levels.

The plurality of receivers 200 can perform wireless communication using time sequence radio wave intensity patterns in which the intensities of transmission radio waves of wireless communication are different from each other.

Specifically, when transmitting a radio signal, the receiver 200 transmits a radio signal while changing in a time sequence, such as Lv1, Lv3, Lv5, Lv2, LV4., for example, every predetermined time (1m seconds). Here, an array of time-sequential radio wave intensity levels consisting of Lv1, Lv3, Lv5, Lv2, LV4. is referred to as a radio wave intensity pattern. The radio wave intensity pattern may be obtained by repeating an array (an array having a finite length) of a predetermined number of radio wave intensity levels. In addition, the arrangement of a predetermined number of radio wave intensity levels may be combined.

Further, the radio wave intensity pattern may be an array (an array having an infinite length) of radio wave intensity levels that are not repeated. In the present disclosure, each of the plurality of receivers 200 transmits a radio signal based on a different radio wave intensity pattern. Note that the different radio wave intensity patterns indicate a case where the radio wave intensity patterns are not common as the whole of the radio wave intensity patterns, and include a case where the radio wave intensity patterns in some periods are common and the radio wave intensity patterns in other periods are not common.

Thus, even when a radio signal is transmitted from the plurality of receivers 200 using a frequency band close to each other, it is possible to reliably succeed in communication with the transmitter 100 with respect to the radio signal transmitted from the receiver 200 having a high radio wave intensity level of 1. Further, since a radio signal transmitted from another receiver 200 at a different timing may have a higher radio wave intensity level than a radio signal transmitted from one receiver 200, communication with the transmitter 100 can be succeeded for another receiver 200. That is, it is possible to avoid that all the plurality of receivers 200 cannot communicate with the transmitter 100.

Thus, when communication is performed between the transmitter and the plurality of receivers, interference of communication radio waves can be suppressed.

The plurality of receivers 200 can perform wireless communication using a radio wave intensity pattern including time sequence consecutive combinations of predetermined radio wave intensity levels among three or more different radio wave intensity levels.

Specifically, the receiver 200 is preferably configured to be capable of selecting a predetermined radio wave intensity level from among three or more radio wave intensity levels. Accordingly, when communication is performed between the transmitter and the plurality of receivers, interference of communication radio waves can be further suppressed.

The plurality of receivers 200 can perform wireless communication with different time sequence radio wave intensity patterns for each transmission slot of data communication in wireless communication.

Specifically, when communicating with the transmitter 100, the receiver 200 performs wireless communication in units of communication slots, which is a time frame for transmitting and receiving data at regular intervals. The communication slot varies depending on the communication method and the standard, and is set in multiples of 1.25m seconds in Bluetooth (registered trademark), for example, and is often set in multiples of 10m seconds in Wi-Fi.

In the present disclosure, the receiver 200 allocates a communication slot for each element of the array of radio wave intensity levels and transmits a wireless signal. The receiver 200 transmits radio signals at Lv4 radio wave strength levels in a Lv1, a second slot, a Lv3, a third slot, a Lv5, a fourth slot, a Lv2, and a fifth slot in the first slot.

Note that the receiver 200 may control the radio wave intensity level not in units of slots but in units of packets and frames. As a result, it is possible to suppress interference of communication radio waves in units of slots, packets, and frames.

The plurality of receivers 200 can perform wireless communication so as to suppress interference of the respective receivers by different time sequence radio wave intensity patterns corresponding to individual identification information assigned to the respective receivers 200.

Specifically, the receiver 200 selects a predetermined radio wave intensity pattern among the plurality of radio wave intensity patterns in accordance with the individual identification number assigned to the receiver, and transmits a radio signal based on the time sequence radio wave intensity in accordance with the radio wave intensity pattern. For example, it is assumed that the receiver 200 is assigned a predetermined individual identification number among 16 independent individual identification numbers 0 to 15.

For example, the receiver 200 having the individual identification number 0 transmits a radio signal with a radio wave intensity according to the radio wave intensity pattern A. The receiver 200 having the individual identification number 1 transmits a radio signal with a radio wave intensity according to the radio wave intensity pattern B. The receiver 200 having the individual identification number 1 transmits a radio signal with a radio wave intensity according to the radio wave intensity pattern C. It is assumed that the radio wave intensity patterns A, B, and C are different time-series radio wave intensity patterns.

Thus, when communication is performed between the transmitter and the plurality of receivers, interference of communication radio waves can be suppressed.

The individual identification numbers of the plurality of receivers 200 are assigned by the transmitter at the timing when the communication connection between the transmitter 100 and the plurality of receivers 200 is made.

Specifically, the individual identification number of the receiver 200 may be allocated from the transmitter 100 at the time of the communication establishment (handshake) of the wireless communication with the transmitter 100. For example, the transmitter 100 assigns a unique individual identification number to each of the plurality of receivers 200.

Note that the handshake at the time of communication establishment in the wireless communication refers to a signal exchanged before the transmitter 100 and the receiver 200 start communication. By this signal exchange, a procedure is performed to enable both of them to communicate with each other. Specifically, the transmitter 100 transmits a signal to the receiver 200 saying "I want to start communication", and when the receiver 200 receives the signal, the receiver 200 returns a response signal. Upon receiving the response signal, the transmitter 100 determines that communication has been established and starts transmitting data. By such a handshake, both of them become communicable, and data transmission and reception starts

### Second Embodiment

The plurality of receivers 200 perform wireless communication with radio wave intensities determined in accordance with the independent probabilities for the respective receivers in a time sequence. The plurality of receivers 200 may be configured such that each of the receivers 200 performs wireless communication with time sequence random radio wave intensities.

Specifically, when transmitting a radio signal, the receiver 200 probabilistically selects a predetermined radio wave intensity level among Lv1, Lv3, Lv5, Lv2, LV4, … at predetermined time intervals (e.g.,every 1m seconds), for example, and transmits a radio signal at the selected radio wave intensity level. For example, the probability of being selected may be uniform (random) at all radio intensity levels, or the probability of being selected for each radio intensity level may be biased. For example, Lv1 may be difficult to select. Also in the second embodiment, the selected radio wave intensity level may be a configuration in which a predetermined radio wave intensity level among three or more radio wave intensity levels is selected.

The receiver 200 probabilistically selects a radio wave intensity level for each transmission slot of data communication in wireless communication, and transmits a radio signal at the selected radio wave intensity level. Note that the receiver 200 may control the radio wave intensity level not in units of slots but in units of packets and frames. Note that the plurality of receivers 200 independently select the radio wave intensity level for each of the receivers. As a result, it is possible to prevent the intensity levels of the radio signals selected by the plurality of receivers 200 from overlapping with each other.

Thus, even when a radio signal is transmitted from the plurality of receivers 200 using a frequency band close to each other, it is possible to reliably succeed in communication with the transmitter 100 with respect to the radio signal transmitted from the receiver 200 having a high radio wave intensity level of 1. Further, since a radio signal transmitted from another receiver 200 at a different timing may have a higher radio wave intensity level than a radio signal transmitted from one receiver 200, communication with the transmitter 100 can be succeeded for another receiver 200. That is, it is possible to avoid that all the plurality of receivers 200 cannot communicate with the transmitter 100.

Thus, when communication is performed between the transmitter and the plurality of receivers, interference of communication radio waves can be suppressed.

In the first embodiment, wireless communication may be performed in a single receiver 200 instead of the plurality of receivers 200 according to a radio wave intensity and a radio wave intensity pattern that differ in a time sequence.

In the second embodiment, wireless communication may be performed at a single receiver 200 instead of the plurality of receivers 200 with a radio wave intensity determined according to the independent probability. The single receiver 200 may perform wireless communication with time sequence random radio wave intensities.

Thus, even in the case of the single receiver 200, it is possible to suppress interference of communication radio waves with other radio devices other than the WPT system 1.

### Third Embodiment

When communication with the transmitter 100 fails, the plurality of receivers 200 perform control to transmit a radio signal to the transmitter so as to suppress interference of the respective receivers 200 with different radio wave intensities.

Specifically, the receiver 200 determines that communication with the transmitter 100 has failed when a proper response is not obtained from the transmitter 100 with respect to the wireless signal transmitted to the transmitter 100. In addition, the receiver 200 may determine that the communication has failed in a case where a predetermined condition such as no response within a predetermined period of time is satisfied after transmitting a wireless signal to the transmitter 100. The condition of the communication failure can define any condition.

When it is determined that communication with the transmitter 100 has failed, the receiver 200 executes radio wave control for radio communication according to the first embodiment and the second embodiment over a predetermined period of time. For example, the receiver 200 may execute radio wave control (interference suppression control) related to the wireless communication according to the first embodiment and the second embodiment over a predetermined period (interference suppression control execution period).

The interference-suppression control duration is preferably 1 millisecond to 50 milliseconds, and more preferably 5 milliseconds to 50 milliseconds for a receiver used in a FA equipment, a robotic device, or the like in which high responsiveness is required. The interference suppression control period may be about several tens of milliseconds to one second in the case of a receiver used for a sensor for monitoring.

Note that the first information processing apparatus notifies a predetermined administrator of a message when the interference suppression control is performed over the interference suppression control period and the communication failure is not resolved. For example, FA equipment, the operator of the production line in which the robotic device is installed, the operator, and the like are notified of a message. Further, the notification may be made by turning on a predetermined warning or the like. This allows the operator of the production line to confirm that the receiver 200 is not properly communicating. Specifically, the operator of the production line can change the installation environment or the like so that the receiver 200 can appropriately perform communication.

Accordingly, even when communication between the transmitter and the plurality of receivers fails, re-interference at the time of retry can be suppressed, and communication between the transmitter and the plurality of receivers can be performed without delay. For example, if the plurality of receivers 200 repeat retries with the same radio wave intensity, the radio waves interfere with each other, and all the receivers 200 cannot communicate with the transmitter 100.

When communication with the transmitter 100 fails, the plurality of receivers 200 execute control for performing wireless communication with different radio wave intensities to the transmitter in accordance with the number of failures.

Specifically, the receiver 200 counts the number of failures when it is determined that communication with the transmitter 100 has failed. When the number of failures becomes equal to or greater than a predetermined number of times, the receiver 200 executes radio wave control related to the radio communication according to the first embodiment and the second embodiment. Specifically, the receiver 200 selects a radio wave intensity pattern corresponding to the number of failures by referring to a table or the like in which different radio wave intensity patterns are stored in accordance with the number of failures. For example, it is assumed that the pattern A, the pattern B, and the pattern C are stored in the table at each of the number of failures 1, 2, and 3. Note that it is not necessarily require to use a table, and a radio wave intensity pattern may be selected according to the number of failures according to a predetermined rule.

Further, the receiver 200 may be configured such that a radio wave intensity pattern having a higher priority than that of the other receivers 200 is selected as the number of failures increases. For example, the receiver 200 may be configured such that a radio wave intensity pattern having a higher average of radio wave intensity levels is selected as the number of failures increases. Further, a configuration may be adopted in which a radio signal is transmitted with a random radio wave intensity having a high average of radio wave intensity levels. As a result, the receiver 200 having a large number of failures is more likely to communicate with the transmitter 100, and can be preferentially treated as compared with the other receivers 200. This is because the receiver 200 having a large number of failures often desires to preferentially treat wireless communication with the transmitter 100.

For example, the receiver 200 may execute radio wave control for wireless communication according to different time sequence radio wave intensity patterns according to the number of failures. Specifically, the receiver 200 may select a predetermined radio wave intensity pattern in accordance with the number of failures among the plurality of time sequence radio wave intensity patterns, and execute radio wave control for wireless communication according to the predetermined radio wave intensity pattern.

For example, the receiver 200 may execute radio wave control for wireless communication with a radio wave intensity determined according to a different probability distribution according to the number of failures. Specifically, the receiver 200 may select a predetermined probability distribution in accordance with the number of failures among the plurality of probability distributions, and perform radio wave control for wireless communication with a radio wave intensity determined in accordance with the predetermined probability distribution.

For example, the receiver 200 may execute radio wave control for wireless communication using different time sequence radio wave intensity patterns according to the individual identification information assigned to each receiver 200 and the number of failures.

### Basic hardware configuration of the computer

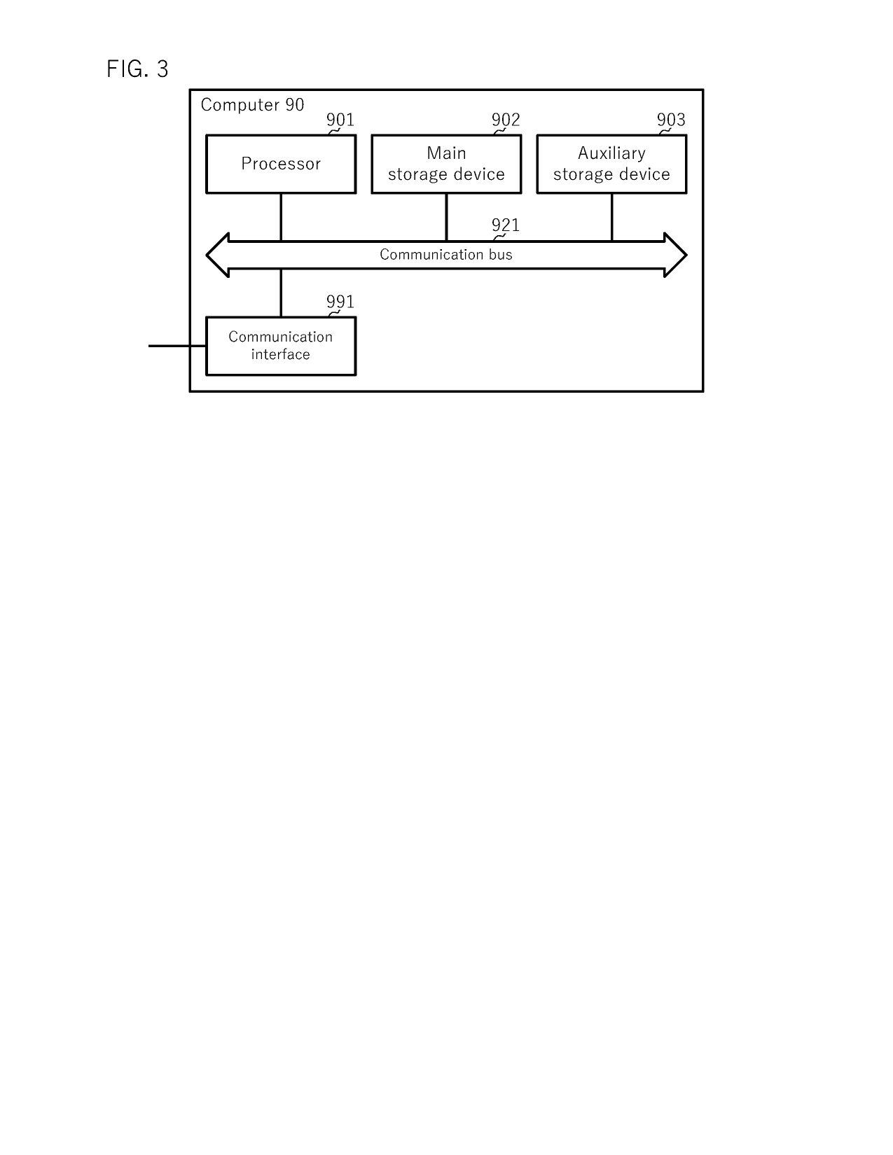

FIG. 3 is a block diagram illustrating a basic hardware configuration of the computer 90. The computer 90 includes at least a processor 901, a main storage device 902, an auxiliary storage device 903, and a communication IF (interface) 991. These are electrically connected to each other by a communication bus 921.

The processor 901 is hardware for executing an instruction set described in a program. The processor 901 includes an arithmetic device, a register, a peripheral circuit, and the like.

The main storage device 902 is for temporarily storing a program, data processed by the program, and the like. For example, volatile memories such as DRAM (Dynamic Random Access Memory).

The auxiliary storage device 903 is a storage device for storing data and programs. Examples include flash memories, HDD (Hard Disc Drive), magneto-optical disks, CD-ROM, DVD-ROM, and solid-state memories.

The communication IF 991 is an interface for inputting and outputting signals for communicating with other computers via a network using a wired or wireless communication standard.

The network is composed of various types of mobile communication systems constructed by the Internet, LAN, radio base stations, and the like. For example, the network includes a 3G, 4G, 5G mobile communication system, a LTE (Long Term Evolution, a radio network (e.g., Wi-Fi) connectable to the Internet by a predetermined access point, and the like. When connecting wirelessly, for example, Z-Wave (registered trademark), ZigBee (registered trademark), Bluetooth (registered trademark) and the like are included as communication protocols. In the case of a wired connection, the network also includes a direct connection by USB (Universal Serial Bus) cable or the like.

Note that the computer 90 can be virtually realized by providing all or a part of each hardware configuration in a plurality of computers 90 in a distributed manner and connecting them to each other via a network. As described above, the computer 90 is a concept including not only a single housing and a computer 90 housed in a case, but also a virtual computer system.

### Basic Functional Configuration of Computer 90

The functional configuration of the computer realized by the basic hardware configuration (FIG. 3) of the computer 90 will be described. The computer includes at least functional units of a control unit, a storage unit, and a communication unit.

It should be noted that the functional units included in the computer 90 may be realized by distributing all or a part of the respective functional units to a plurality of computers 90 connected to each other via a network. Computer 90 is a concept that includes not only a single computer 90, but also a virtual computer system.

The control unit is realized by the processor 901 reading out various programs stored in the auxiliary storage device 903, expanding the programs in the main storage device 902, and executing processing in accordance with the programs. The control unit can implement a functional unit that performs various information processing according to the type of the program. Thus, the computer is realized as an information processing apparatus that performs information processing.

The storage unit is realized by the main storage device 902 and the auxiliary storage device 903. The storage unit stores data, various programs, and various databases. In addition, the processor 901 can secure a storage area corresponding to the storage unit in the main storage device 902 or the auxiliary storage device 903 according to the program. In addition, the control unit can cause the processor 901 to perform processing for adding, updating, and deleting data stored in the storage unit in accordance with various programs.

The database refers to a relational database, and is used to manage a tabular table structurally defined by rows and columns, and a data set called a master, in association with each other. In a database, a table is called a table, a master, a column of a table is called a column, and a row of a table is called a record. In the relational database, relationships between tables and masters can be set and associated.

Normally, each table and each master is set with a column that serves as a primary key for uniquely identifying a record, but the setting of the primary key to the column is not required. The control unit can cause the processor 901 to add, delete, and update a record to a specific table and a master stored in the storage unit in accordance with various programs.

Further, by storing data, various programs, and various databases in the storage unit, the information processing apparatus and the information processing system according to the present disclosure can be regarded as being manufactured.

Note that the database and the master in the present disclosure may include any data structure (a list, a dictionary, an associative array, an object, or the like) in which information is structurally defined. A data structure shall also contain data that may be considered a data structure by combining the data with functions, classes, methods, etc. described in any programming language.

The communication unit is realized by a communication IF 991. The communication unit implements a function of communicating with another computer 90 via a network. The communication unit can receive information transmitted from another computer 90 and input the information to the control unit. The control unit can cause the processor 901 to execute information processing on the received information in accordance with various programs. Further, the communication unit can transmit the information output from the control unit to the other computer 90.

### Supplementary notes

Items described in the above embodiments will be described below.

### Configuration 1

In a wireless power supply system composed of at least one transmitter and a plurality of receivers, a transmitter (100) can wirelessly supply power to a plurality of receivers, and a plurality of receivers (200) can wirelessly communicate with the transmitter so as to suppress interference of the respective receivers by different time sequence radio wave intensities.

Thus, when communication is performed between the transmitter and the plurality of receivers, interference of communication radio waves can be suppressed.

### Configuration 2

The wireless power supply system according to configuration 1, wherein the plurality of receivers (200) can transmit the sensing data acquired by the sensing device included in the receiver to the transmitter via wireless communication.

Thus, the transmitter can acquire data sensed by a sensing device such as a sensor included in the receiver with low delay by suppressing interference of communication radio waves.

### Configuration 3

The wireless power supply system according to configuration 1 or 2, wherein the plurality of receivers (200) are capable of performing wireless communication using different time sequence radio wave intensity patterns.

Accordingly, when communication is performed between the transmitter and the plurality of receivers, interference of communication radio waves can be suppressed more reliably.

### Configuration 4

The wireless power supply system according to any one of configurations 1 to 3, wherein each of the plurality of receivers (200) is capable of performing wireless communication by a radio wave intensity pattern including a time sequence continuous combination of predetermined radio wave intensity levels among three or more different radio wave intensity levels.

Accordingly, when communication is performed between the transmitter and the plurality of receivers, interference of communication radio waves can be suppressed more reliably.

### Configuration 5

The wireless power supply system according to any one of configurations 1 to 4, wherein the plurality of receivers (200) can perform wireless communication using different time sequence radio wave intensity patterns for each transmission slot of data communication in wireless communication.

Accordingly, when communication is performed between the transmitter and the plurality of receivers, interference of communication radio waves can be suppressed in units of communication slots.

### Configuration 6

The wireless power supply system according to any one of configurations 1 to 5, wherein the plurality of receivers (200) can perform wireless communication so as to suppress interference of the respective receivers by different time sequence radio wave intensity patterns corresponding to individual identification information assigned to the respective receivers.

Thus, when communication is performed between the transmitter and the plurality of receivers, interference of communication radio waves can be suppressed.

### Configuration 7

The wireless power supply system according to configuration 6, wherein the individual identification numbers of the plurality of receivers are assigned by the transmitter at a timing at which a communication connection between the transmitter and the plurality of receivers is made.

Thus, the wireless communication can be performed in accordance with the individual identification number assigned to the receiver at the timing when the communication connection is made between the transmitter and the receiver. When communication is performed between a transmitter and a plurality of receivers, interference of communication radio waves can be suppressed.

### Configuration 8

The wireless power supply system according to configuration 1 or 2, wherein the plurality of receivers (200) are capable of performing wireless communication with a radio wave intensity determined according to a probability of being independent for each of the receivers in a time sequence.

Thus, when communication is performed between the transmitter and the plurality of receivers, interference of communication radio waves can be suppressed.

### Configuration 9

The wireless power supply system according to configuration 8, wherein each of the plurality of receivers (200) is capable of performing wireless communication with time sequence random radio wave intensities.

Thus, when communication is performed between the transmitter and the plurality of receivers, interference of communication radio waves can be suppressed.

### Configuration 10

The wireless power supply system according to any one of configurations 1 to 9, wherein when communication with the transmitter fails, the plurality of receivers (200) perform control for performing wireless communication with the transmitter so as to suppress interference of the respective receivers at different radio wave intensities.

Accordingly, even when communication between the transmitter and the plurality of receivers fails, re-interference at the time of retry can be suppressed, and communication between the transmitter and the plurality of receivers can be performed without delay.

### Configuration 11

The wireless power supply system according to configuration 10, wherein when communication with the transmitter fails, the plurality of receivers (200) execute control for performing wireless communication with the transmitter at different radio wave intensities in accordance with the number of failures.

Accordingly, even when communication between the transmitter and the plurality of receivers fails, re-interference at the time of retry can be suppressed, and communication between the transmitter and the plurality of receivers can be performed without delay.

### Configuration 12

The wireless power supply system according to configuration 11, wherein when communication with the transmitter fails, the plurality of receivers (200) execute control to perform wireless communication with a radio wave intensity having a larger average of radio wave intensities as the number of failures increases.

As a result, the receiver 200 having a large number of failures is more likely to communicate with the transmitter 100, and can be more favorably treated than the other receivers 200.

### Configuration 13

The wireless power supply system according to configuration 10, wherein, when communication with the transmitter fails, the plurality of receivers (200) execute control for performing wireless communication with the transmitter for a predetermined period of time so as to suppress interference of the respective receivers at different radio wave intensities, and when communication failure with the transmitter does not resolve in a predetermined period of time, notify a predetermined administrator.

This allows the operator of the production line to confirm that the receiver 200 is not properly communicating.

### Configuration 14

The wireless power supply device according to any one of configurations 1 to 13, wherein the wireless power supply device is used for transmitting and receiving wireless power of a FA or a robotic device.

Low-latency wireless communication can be established while suppressing interference between the transmitter and the receiver. This makes it possible to control FA, the robot device, and the like with low delay even in a technical area where real-time properties such as FA(Factory Automation) and control of the robot device are required.

### Explanation of Reference numerals

1... WPT system (or wireless power transfer system),

300... First information processing device,

3001... Storage unit,

3004... Control unit,

3006... Input device,

3008... Output device,

400... Second information processing device,

4001... Storage unit,

4004... Control unit,

4006... Input device,

4008... Output device,

100... Transmitter,

200... Receiver.

What is claimed is:

1. A wireless power transfer system, comprising:
at least one transmitter; and
a plurality of receivers,
wherein the transmitter is capable of wirelessly transfer power to the plurality of receivers,
wherein the plurality of receivers are capable of performing wireless communication with the transmitter by using radio wave intensities that vary in a time sequence so as to suppress interference among the respective receivers, and
wherein the plurality of receivers are capable of performing wireless communication with radio wave intensities that are determined in a time sequence according to independent probabilities for the respective receivers.

2. The wireless power transfer system according to claim 1, wherein each of the plurality of receivers is capable of performing wireless communication with radio wave intensities that are randomly determined in a time sequence.

3. A wireless power transfer system, comprising:
at least one transmitter; and
a plurality of receivers,
wherein the transmitter is capable of wirelessly transfer power to the plurality of receivers,
wherein the plurality of receivers are capable of performing wireless communication with the transmitter by using radio wave intensities that vary in a time sequence so as to suppress interference among the respective receivers, and
wherein the plurality of receivers are capable of performing wireless communication by using a radio wave intensity pattern composed of a time-sequential combination of predetermined radio wave intensity levels selected from among three or more different radio wave intensity levels.

4. A wireless power transfer system, comprising:
at least one transmitter; and
a plurality of receivers,
wherein the transmitter is capable of wirelessly transfer power to the plurality of receivers,
wherein the plurality of receivers are capable of performing wireless communication with the transmitter by using radio wave intensities that vary in a time sequence so as to suppress interference among the respective receivers, and
wherein the plurality of receivers are capable of performing wireless communication by using a time-sequential radio wave intensity pattern that differs for each transmission slot of data communication in the wireless communication.

5. A wireless power transfer system, comprising:
at least one transmitter; and
a plurality of receivers,
wherein the transmitter is capable of wirelessly transfer power to the plurality of receivers,
wherein the plurality of receivers are capable of performing wireless communication with the transmitter by using radio wave intensities that vary in a time sequence so as to suppress interference among the respective receivers, and
wherein the plurality of receivers are capable of performing wireless communication by using a time-sequential radio wave intensity pattern that differs according to individual identification information assigned to the respective receivers, so as to suppress interference among the respective receivers.

6. The wireless power transfer system according to claim 5, wherein individual identification numbers of the plurality of receivers are assigned by the transmitter at a timing when a communication connection is established between the transmitter and the plurality of receivers.

7. A wireless power transfer system, comprising:
at least one transmitter; and
a plurality of receivers,
wherein the transmitter is capable of wirelessly transfer power to the plurality of receivers,
wherein the plurality of receivers are capable of performing wireless communication with the transmitter by using radio wave intensities that vary in a time sequence so as to suppress interference among the respective receivers, and
wherein in a case that communication with the transmitter has failed, the plurality of receivers execute control to perform wireless communication with the transmitter by using different radio wave intensities so as to suppress interference among the respective receivers.

8. The wireless power transfer system according to claim 7, wherein in a case that communication with the transmitter has failed, the plurality of receivers execute control to perform wireless communication with the transmitter by using radio wave intensities that differ according to the number of failures.

9. The wireless power transfer system according to claim 7, wherein in a case that communication with the transmitter has failed, the plurality of receivers execute control to perform wireless communication by using radio wave intensities whose average value is an increasing function of the number of failures.

10. The wireless power transfer system according to claim 7, wherein in a case that communication with the transmitter has failed, the plurality of receivers execute control, over a predetermined period, to perform wireless communication with the transmitter by using different radio wave intensities so as to suppress interference among the respective receivers, and
wherein in a case that the failure of the communication with the transmitter is not resolved during the predetermined period, a notification is provided to a predetermined administrator.

11. The wireless power transfer system according to claim 1, wherein the plurality of receivers are capable of transmitting sensing data acquired by sensing devices provided in the receivers, to the transmitter via the wireless communication.

12. The wireless power transfer system according to claim 1, wherein the plurality of receivers are capable of performing wireless communication by using different time-sequential radio wave intensity patterns.
